(19) United States
(12) Patent Application Publication
(10) Pub. No.: US 2022/0167098 A1
(43) Pub. Date: May 26, 2022

(54) HEARING AID

(71) Applicants: James C. Young, Fargo, ND (US); Maria Angelica Young, Fargo, ND (US)

(72) Inventors: James C. Young, Fargo, ND (US); Maria Angelica Young, Fargo, ND (US)

(21) Appl. No.: 17/531,644

(22) Filed: Nov. 19, 2021

Related U.S. Application Data
(60) Provisional application No. 63/118,313, filed on Nov. 25, 2020.

(51) Int. Cl. H04R 25/00

(52) U.S. Cl. CPC H04R 25/43; H04R 25/65

(57) ABSTRACT

A portable assistive listening system for enhancing sound for hearing impaired individuals includes a fully functional hearing aid and a separate handheld digital signal processing (DSP) device. The focus of the present invention is directed to the handheld DSP device. The DSP device includes a programmable digital signal processor, a UWB transceiver for communicating with the hearing aid and/or other wireless audio sources, an LCD display, and a user input device (keypad). The handheld device is user programmable to apply different processing algorithms for processing sound signals received from the hearing aid or other audio source. The handheld device is capable of receiving audio signals from multiple sources and gives the user control over selection of incoming sources and selective processing of sound. In the context of being user programmable, the digital signal processing device includes a software platform that provides for the ability of the user to select or “plug-in” desired processing algorithms for application to selected incoming audio channels and a communication port for the user to connect to a PC or other device to download preferred processing algorithms. The communication port provides the user with the ability to retrieve desirable processing algorithms from a database of available algorithms and download those algorithms directly into the device for use.

### BACKGROUND OF THE INVENTION

The instant invention relates to an assistive listening system including a hearing aid and a wireless, handheld, programmable digital signal processing device.

Programmable, “at-ear”, hearing aids are well-known in the art. When using the term “at-ear”, the Applicant intends to include all types of hearing aids that are located in the vicinity of the ear, such as Completely-in-the-Canal (CIC) hearing aids, Mini-Canal (MC) hearing aids, In-the-Canal (ITC) hearing aids, Half-Shell (HS) hearing aids, In-the-Ear (ITE) hearing aids, Behind-the-Ear (BTE) hearing aids, and Open-fit Mini-BTE hearing aids.

Prior art programmable hearing aids typically include a small, low-power digital audio processing device, or digital signal processor (DSP), which locally receives an audio input from an on-board microphone, processes the audio input and outputs the audio directly to the wearer through a small speaker. A DSP is specifically designed to perform the audio signal analysis and computation required to deliver the clearest sound to the user. This analysis and computation involve reshaping the audio signals using mathematical equations (algorithms). Because of the size of a typical at-ear hearing aid, audio processing power is limited and thus functionality is typically limited to just one audio processing algorithm (fixed set of calculations) and often a single hearing profile. Modifications to the hearing profile (personalized adjustments) typically require a trip to an audiologist to connect the hearing aid to a special interface to make adjustments. An audiologist can change the variables for the fixed set of calculations but cannot change the calculations which are built into the hardware of the DSP. This process is akin to changing the equalizer settings where the gain of certain frequency ranges is increased or decreased depending on the wearer's hearing loss.

Programmable hearing aids that include the ability to process audio signals according to multiple hearing profiles are also well known in the art. In these devices, the audiologist is able to program multiple profiles into the hearing aid memory, and the user is able to select a particular hearing profile by manually actuating a switch on the hearing aid corresponding to the desired setting. However, the underlying processing algorithm (fixed mathematical calculations) remains the same.

Some of these multiple-profile hearing aids include a separate handheld programming device that can selectively push a programming profile to the hearing aid at the direction of the user. Alternatively, the handheld programming device samples ambient sound with an on-board microphone, analyzes the audio signal and then automatically sends (pushes) a programming signal to the earpiece to tell the earpiece how to process the audio signal (automatically sets the hearing profile). These separate handheld devices do have digital signal processing capabilities and due process ambient audio, but the processed audio is not transmitted back to the earpiece. Only a programming signal is transmitted back to the hearing aid. The actual signal processing is still completed in the hearing aid based on the hearing profile determined by the handheld device.

Assistive listening systems having a wireless earpiece and a separate handheld or base unit are also well known in the art. Some of these prior art systems provide for digital processing in the separate device, while others are simply wireless repeaters for taking in audio signals from a source and transmitting it to the earpiece. However, one aspect of these prior art systems is that the systems that provide for digital signal processing (DSP) in the handheld unit remove the audio signal processing capabilities from the earpiece. Where the DSP capabilities are preserved in the earpiece, the handheld or base unit is simply being used as a signal repeater.

### SUMMARY OF THE INVENTION

While the prior art programmable hearing aids and assistive listening devices have served the market for many years, demographics are rapidly changing such that many people are now comfortable with electronic devices and computers, and society now generally embraces the concept of all people carrying and wearing listing devices, such as MP3 players. It is believed that there is an unmet need for a versatile and powerful assistive listening system that combines the known benefits of at-ear hearing aids with the powerful programming and processing capabilities that are now available in advanced digital signal processors. By supplementing the audio processing functions of the hearing aid with a separate digital signal processing device, which can accommodate a larger audio processor, memory, input and output ports, the user can significantly enhance the usability and overall functionality of hearing devices.

In one embodiment, the assistive listening system includes a hearing aid and a wireless, handheld, programmable digital signal processing device. Alternatively the programmable digital signal processing device is included in the hearing aid.

The hearing aid generally includes all of the components of a programmable hearing aid, i.e., microphone, digital signal processor, speaker and power source. The hearing aid also includes an analog amplifier and a wireless ultra-wide band (UWB) transceiver for communicating with an optional separate handheld digital signal processor device.

The digital signal processing device generally includes a programmable digital signal processor, a UWB transceiver for communicating with the hearing aid, an LCD display, and a user input device (keypad). Other wireless transmission technologies are also contemplated.

The handheld device may be user programmable to accept different processing algorithms for processing audio signals received from the hearing aid. The handheld device may also be capable of receiving audio signals from multiple sources and gives the user control over selection of incoming sources and selective processing of audio signals.

Another embodiment is the use of the device to play pre-programmed messages, content, books, another audio to the user. Alternatively, the handheld device, such as a phone, laptop computer, or other device can stream live programming to the device.

Other objects, features, and advantages of the invention shall become apparent as the description thereof proceeds when considered in connection with the accompanying illustrative drawings.

### BRIEF DESCRIPTION OF THE DRAWINGS

FIG. 1 shows the device that can be used as a hearing aid.

### DETAILED DESCRIPTION

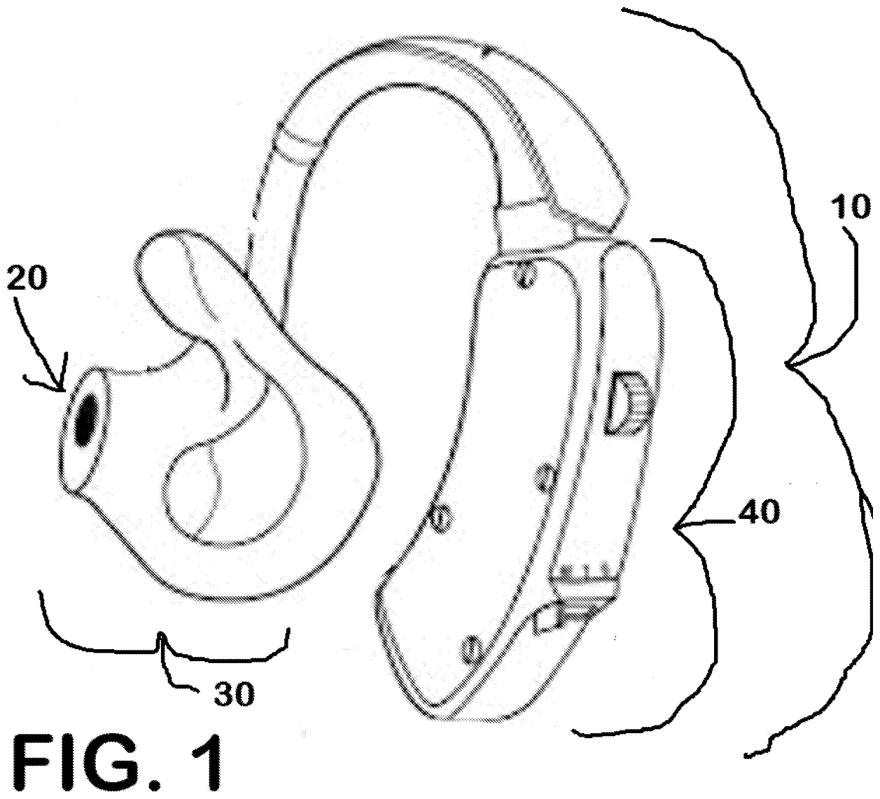

The hearing aid generally includes components of a programmable hearing aid, i.e., a microphone, a digital signal processor, a speaker and a power source. In the context of converting analog signal data from the microphone to digital signal data for compatibility with the DSP and vice versa for the speaker the hearing aid also includes an analog to digital converter (A/D) and a digital to analog converter (D/A). As seen in FIG. 1 the device, 10, has a moldable ear piece, 20, and ear piece base, 30, that fits in user's ear. The device can also include a containment housing, 40, for a computer and hard drive to operate the device outside of external control systems. Basic construction and operation of the programmable hearing aid is known in the art and will not be described further.

In accordance with the invention, the hearing aid also includes an analog amplifier and a wireless Ultra-Wide Band (UWB) transceiver and antenna for communicating with the separate handheld digital signal processor device.

While the current embodiment has Ultra-Wide Band (UWB) wireless communication as the preferred wireless transmission technology for transmitting and receiving data between the hearing aid and the handheld device, other systems can be used. UWB is known for its fast transfer speeds and ability to handle large amounts of data. While the Applicant has selected UWB as the preferred wireless transmission technology, it is to be understood that other wireless technologies, such as Infra-Red, WiFi, Bluetooth® (Bluetooth is a registered trademark of Bluetooth Sig, Inc), etc. are also suitable for accomplishing the same purpose (although at lower data rates and greater latency). The device can also utilize a hard drive, computer processing units and other similar devices to attain the desired results.

The handheld digital signal processing (DSP) device generally includes a programmable digital signal processor (DSP), a UWB transceiver and antenna for communicating with the hearing aid (and other UWB input devices), an LCD display, a user input device (keypad or touchscreen) and a rechargeable battery power system.

The programmable DSP is preferably a high-power audio processing device, such as Analog Devices®, Blackfin® BF-538 DSP, although other similar devices would also be suitable for use in connection with the invention (Analog Devices® and Blackfin® are trademarks or registered trademarks of Analog Devices Corp.).

The UWB transceiver is similar to the UWB transceiver in the hearing aid and is capable of wireless communication with the UWB transceiver in the hearing aid.

The LCD screen is a standard component that is well known in the industry and will not be described in further detail.

The user input device is preferably defined as a keypad input. However, the Applicant also contemplates the use of a touch-screen input (not shown), as well as other mechanical and electrical inputs, scroll wheels, and other touch-based input devices. Where the input device is a touch screen, the LCD and input device are combined into a single hardware unit. Touch-screen LCD devices are well known in the art and will not be described in further detail.

The rechargeable battery system includes a rechargeable battery, such as a conventional high capacity, lithium-ion battery, and a power management circuit to control battery charging and power distribution to the various components of the handheld DSP device.

In operation of the basic system, the hearing aid(s) can independently operate without the handheld DSP device with the inclusion of a hard drive and CPU internal to the device. The hearing aid includes its own microphone, its own DSP that can receive and process audio according to prior art processing methods, a memory chip to which pre-programmed messages and programming can be downloaded, and its own speaker for outputting audio directly to the wearer's ear.

In regard to the processing systems of the disclosed apparatus, a “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with interne access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128 s or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Intexhaust gas recirculating Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM®, MQSeries®, technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., in the exhaust gas recirculating rated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer usable medium(s) having computer usable program code embodied thereon.

Any combination of one or more computer usable medium(s) may be utilized. The computer usable medium may be a computer usable signal medium or a non-transitory computer usable storage medium. A computer usable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer usable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer usable storage medium may be any tangible medium that can contain or store a program for use by or in connection with an instruction execution system, apparatus, or device.

A computer usable signal medium may include a propagated data signal with computer usable program code embodied therein, for example, in baseband or as part of a carrier wave. Such a propagated signal may take any of a variety of forms, including, but not limited to, electromagnetic, optical, or any suitable combination thereof. A computer usable signal medium may be a computer usable medium that is not a computer usable storage medium and that can communicate, propagate, or transport a program for use by or in connection with an instruction execution system, apparatus, or device.

Program code embodied on a computer usable medium may be transmitted using any appropriate medium, including but not limited to wireless, wireline, optical fiber cable, RF, etc., or any suitable combination of the foregoing. Further, a computer storage medium may contain or store a computer-usable program code such that when the computer-usable program code is executed on a computer, the execution of this computer-usable program code causes the computer to transmit another computer-usable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for controlling a hearing aid based on an adjustable policy. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims. For example, although a Blackfin™ digital signal processor is identified and described as the preferred device for processing, it is also contemplated that other devices, such as ASIC's, FPGA's, RISC processors, CISC processors, etc. could also be used to perform at least some of the calculations required herein. Additionally, although the invention focuses on the use of the present system for the hearing impaired, it is contemplated that individuals with normal hearing could also benefit from the present system. In this regard, there are potential applications of the present system in military and law enforcement situations, as well as for the general population in situations where normal hearing is impeded by excessive environment noise.

1. A hearing aid system comprising:
An application paired to a hearing aid wherein the application allows a user to select a source of sound that is to be transmitted to the hearing aid;
A hearing aid comprising a housing which defines a top area, a bottom area, a front area and a rear area and is formed of a first shell part and a second shell part, said first and second shell parts being detachably connected, along lines of separation extending at least partly between said top and bottom areas and along lateral sides of said housing between said front and rear areas, said first and second shell parts defining respective internal slots which are aligned along a plane,
a receiver mounted within said housing,
a means connected to said housing for containing a battery,
an amplifier mounted within said housing, said amplifier including a circuit board which fits within said slots defined by said first and second shell parts, and
a hook attached to said top area of said housing for transmitting acoustic signals from the receiver into an ear of a user.
